(19) United States
(12) Patent Application Publication
(10) Pub. No.: US 2019/0205918 A1
(43) Pub. Date: Jul. 4, 2019

(54) IDENTIFYING AND ADJUSTING FOR SYSTEMIC BIASES IN QUALITY METRICS OF CONTENT

(71) Applicant: Facebook, Inc., Menlo Park, CA (US)

(72) Inventors: Taedong Kim, Mountain View, CA (US); Zhiye Fei, Cupertino, CA (US); Jianfei Wu, Fremont, CA (US); Lei Wang, Santa Clara, CA (US); Tanmoy Chakraborty, San Mateo, CA (US)

(21) Appl. No.: 15/858,402

(22) Filed: Dec. 29, 2017

(51) Int. Cl. G06Q 30/02; G06N 99/00

(52) U.S. Cl. CPC G06Q 30/0243; G06N 99/005

(57) ABSTRACT

An online system accesses a plurality of posts associated with a quality metric used to subsidize or penalize an associated bid amount when competing for presentation. Each of the plurality of posts receives a quality rating from a professional rating service. The professional quality rating is considered to be ground truth. A mathematical function is used to describe the relationship between the professional quality rating and the quality metric determined by the system. The plurality of posts is segmented into categories. Based on whether the categories of posts fall above or below the mathematical function by more than a threshold amount, the system identifies an unfair subsidy or penalty associated with the category of content and adjusts the associated quality metric accordingly.

### BACKGROUND

This disclosure relates generally to determining bids for content for presentation to users of an online system, and more specifically to identifying systemic biases in quality metrics of content.

Users and enterprises may post content to online systems to be shared between other users of the online system. It is valuable for an online system to promote posts with which a viewing user is likely to interact through actions such as liking, sharing, commenting, and performing other types of user engagement. This likelihood to interact is determined according to multiple factors. For example, the online system might account for factors such as the connection between a viewing user and a posting user, the interests of the viewing user, the timestamp of the post, and others.

When enterprises submit sponsored content for presentation to users of the online system, the quality of the post may influence the viewing user's experience of the post and the likelihood that the viewing user will interact with the post. A poor quality post may contain undesirable features such as misleading text or images, technical glitches, a poor quality external link, or others. Because the online system benefits from providing high quality content to users of the online system, the scores for the content items competing for placement may include a quality component determined by the system, which tends to increase the ranking of good quality posts and decrease the ranking of poor quality posts.

Since content delivered by online systems must be ranked by automated processes, given the scale, the determined quality component may introduce systemic biases against certain types of content due to biases in the models used by the online system to rank the content. For example, content promoting a given category of products or having similar goals may systemically receive unfair penalties, while other categories or topics may experience unfair subsidies. This systematic bias reduces the accuracy of the models that predict the quality of content, which in turn results in a bias in the type of content ultimately presented to viewing users of the online system.

### SUMMARY

An online system identifies systemic biases predicting the quality of certain types of content by comparing the quality component of the scores for different types of content items against professional rating scores for the content. In this context, the online system uses a quality component to subsidize or penalize a score for various content items during a selection process for presenting content to a user of the system. The score is determined by the online system using a machine learning model that predicts a quality component for each content item based on information about the content item. The model may be based on characteristics of a user to whom the content item is to be presented, thereby personalizing the prediction for the user.

To measure possible biases in this model used to predict content quality, professional rating services, which may be third party services, are used to determine a ground truth quality score for each of a plurality of content items. The content items are organized into a plurality of different types of content item (e.g., videos, photos, posts, check-ins, etc.). The system determines a relationship between the professional ratings and the predicted quality components for all of the content items. The system then compares the content items for each type to the relationship describing all content items to identify any types of content for which there is a statistically significant difference between the determined relationship for all content items and the content items of the particular type. This allows the system to determine adjustments for certain types of content items, thereby determining subsidies or penalties to offset the biases in the model used to determine quality components of the ranking score for different types of content during the selection process.

More specifically, based on the types of content item that have been determine to experience unfair subsidies or penalties, the system can adjust the quality component of the score for those content items to eliminate this bias of the system. For example, content with similar characteristics identified to experience an unfair subsidy may be adjusted downward, while content with similar characteristics identified to experience an unfair penalty may be adjusted upward. By identifying biases in quality metrics determined by the system and adjusting the quality metrics associated with content experiencing an unfair penalty or subsidy, the system ensures that content presented to the user does not reflect the bias of the metrics system and reduces bias from propagating when new content is received and competes for presentation.

### BRIEF DESCRIPTION OF THE DRAWINGS

FIG. 1 is a block diagram of a system environment in which an online system operates, in accordance with an embodiment.

FIG. 2 is a block diagram of an architecture of the online system, in accordance with an embodiment.

FIG. 3 is an example illustrating relationships between the professional ratings and the predicted quality components for different types of content items, in accordance with an embodiment.

FIG. 4 is a flow diagram of a method for identifying and adjusting for systemic biases in quality components of a score for different types of content items, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

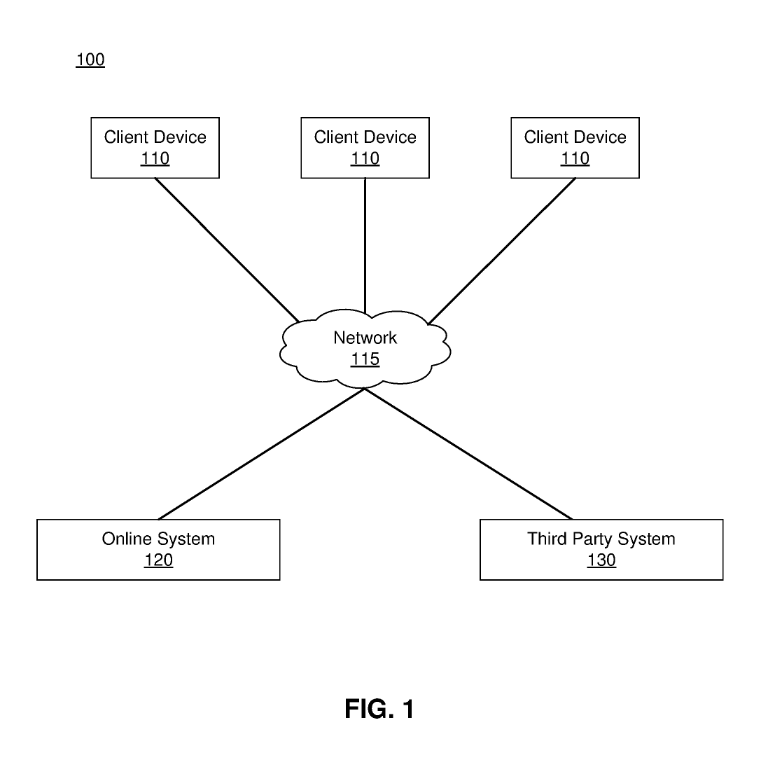

FIG. 1 is a block diagram of a system environment 100 for an online system 120. The system environment 100 shown by FIG. 1 comprises one or more client devices 110, a network 115, one or more third-party systems 130, and the online system 120. In alternative configurations, different and/or additional components may be included in the system environment 100. For example, the online system 120 is a social networking system, a content sharing network, or another system providing content to users.

The client devices 110 are one or more computing devices capable of receiving user input as well as transmitting and/or receiving data via the network 115. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 115. In one embodiment, a client device 110 executes an application allowing a user of the client device 110 to interact with the online system 120. For example, a client device 110 executes a browser application to enable interaction between the client device 110 and the online system 120 via the network 115. In another embodiment, a client device 110 interacts with the online system 120 through an application programming interface (API) running on a native operating system of the client device 110, such as IOS® or ANDROID™.

The client devices 110 are configured to communicate via the network 115, which may comprise any combination of local area and/or wide area networks, using both wired and/or wireless communication systems. In one embodiment, the network 115 uses standard communications technologies and/or protocols. For example, the network 115 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 115 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 115 may be represented using any suitable format, such as hypertext markup language (HTML) or extensible markup language (XML). In some embodiments, all or some of the communication links of the network 115 may be encrypted using any suitable technique or techniques.

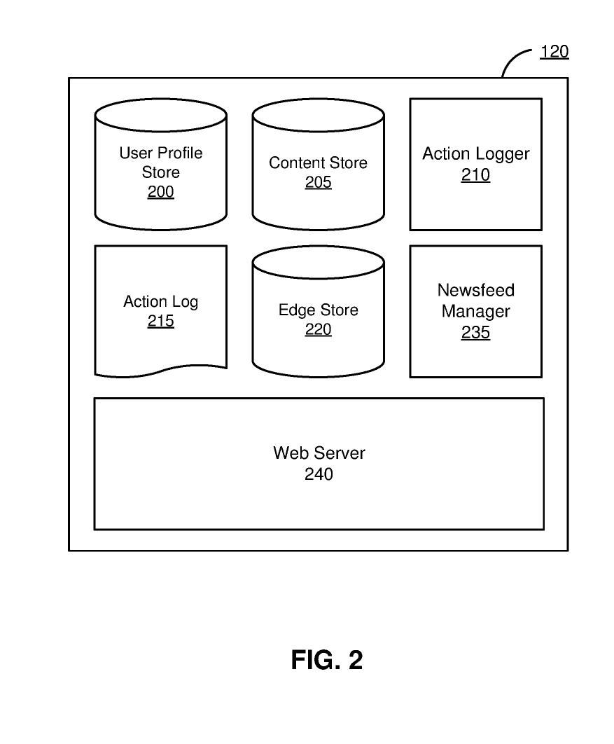

One or more third party systems 130 may be coupled to the network 115 for communicating with the online system 120, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 120, such as advertisements, content, or information about an application provided by the third party system 130.

FIG. 2 is a block diagram of an architecture of the online system 120. The online system 120 shown in FIG. 2 includes a user profile store 200, a content store 205, an action logger 210, an action log 215, an edge store 220, a newsfeed manager 235, and a web server 240. In other embodiments, the online system 120 may include additional, fewer, or different components for various applications. Conventional components such as network interfaces, security functions, load balancers, failover servers, management and network operations consoles, and the like are not shown so as to not obscure the details of the system architecture.

Each user of the online system 120 is associated with a user profile, which is stored in the user profile store 200. A user profile includes declarative information about the user that was explicitly shared by the user and may also include profile information inferred by the online system 120. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 200 may also maintain references to actions by the corresponding user performed on content items in the content store 205 and stored in the action log 215.

While user profiles in the user profile store 200 are frequently associated with individuals, allowing individuals to interact with each other via the online system 120, user profiles may also be stored for entities such as businesses or organizations. This allows an entity to establish a presence on the online system 120 for connecting and exchanging content with other online system users. The entity may post information about itself, about its products or provide other information to users of the online system 120 using a brand page associated with the entity's user profile. Other users of the online system 120 may connect to the brand page to receive information posted to the brand page or to receive information from the brand page. A user profile associated with the brand page may include information about the entity itself, providing users with background or informational data about the entity.

The content store 205 stores objects that each represent various types of content items. Examples of content items include a page post, a status update, a photograph, a video, a link, a shared content item, a sponsored content item (e.g., an advertisement), a gaming application achievement, a check-in event at a local business, a brand page, or any other type of content. The content may be posted to the online system 120 by users of the system, administrators of pages on the system 12, or other third parties, and the content items may be provided to the system 120, directly or indirectly via third parties, using a web page or native application interface or using APIs. Online system users may create objects stored by the content store 205, such as status updates, photos tagged by users to be associated with other objects in the online system 120, events, groups or applications. In some embodiments, objects are received from third-party applications or third-party applications separate from the online system 120. In one embodiment, objects in the content store 205 represent single pieces of content, or content “items.” Hence, online system users are encouraged to communicate with each other by posting text and content items of various types of media to the online system 120 through various communication channels. This increases the amount of interaction of users with each other and increases the frequency with which users interact within the online system 120.

One or more content items included in the content store 205 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 120 if content in the content item is presented to a user, if the content in the content item receives a user interaction when presented, or if any suitable condition is satisfied when content in the content item is presented to a user. For example, the bid amount included in a content item specifies a monetary amount that the online system 120 receives from a user who provided the content item to the online system 120 if content in the content item is displayed. In some embodiments, the expected value to the online system 120 of presenting the content from the content item may be determined by multiplying the bid amount by a probability of the content of the content item being accessed by a user.

In various embodiments, a content item includes various components capable of being identified and retrieved by the online system 120. Example components of a content item include: a title, text data, image data, audio data, video data, a landing page, a user associated with the content item, or any other suitable information. The online system 120 may retrieve one or more specific components of a content item for presentation in some embodiments. For example, the online system 120 may identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 120 logs interactions between users presented with the content item or with objects associated with the content item. Additionally, the online system 120 receives compensation from a user associated with content item as online system users perform interactions with a content item that satisfy the objective included in the content item.

Additionally, a content item may include one or more targeting criteria specified by the user who provided the content item to the online system 120. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 120. Targeting criteria may also specify interactions between a user and objects performed external to the online system 120, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 210 receives communications about user actions internal to and/or external to the online system 120, populating the action log 215 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 215.

The action log 215 may be used by the online system 120 to track user actions on the online system 120, as well as actions on third party systems 130 that communicate information to the online system 120. Users may interact with various objects on the online system 120, and information describing these interactions is stored in the action log 215. Examples of interactions with objects include: commenting on posts, sharing links, checking in to physical locations via a client device 110, accessing content items, and any other suitable interactions. Additional examples of interactions with objects on the online system 120 that are included in the action log 215 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 215 may record a user's interactions with advertisements on the online system 120 as well as with other applications operating on the online system 120. In some embodiments, data from the action log 215 is used to infer interests or preferences of a user, augmenting the interests included in the user's user profile and allowing a more complete understanding of user preferences.

The action log 215 may also store user actions taken on a third party system 130, such as an external website, and communicated to the online system 120. For example, an e-commerce website may recognize a user of an online system 120 through a social plug-in enabling the e-commerce website to identify the user of the online system 120. Because users of the online system 120 are uniquely identifiable, e-commerce web sites, such as in the preceding example, may communicate information about a user's actions outside of the online system 120 to the online system 120 for association with the user. Hence, the action log 215 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 210 by the application for recordation and association with the user in the action log 215.

In one embodiment, the edge store 220 stores information describing connections between users and other objects on the online system 120 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 120, such as expressing interest in a page on the online system 120, sharing a link with other users of the online system 120, and commenting on posts made by other users of the online system 120. Edges may connect two users who are connections in a social network, or may connect a user with an object in the system. In one embodiment, the nodes and edges form a complex social network of connections indicating how users are related or connected to each other (e.g., one user accepted a friend request from another user to become connections in the social network) and how a user is connected to an object due to the user interacting with the object in some manner (e.g., “liking” a page object, joining an event object or a group object, etc.). Objects can also be connected to each other based on the objects being related or having some interaction between them.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 120, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 220 also stores information about edges, such as affinity scores for objects, interests, and other users. Affinity scores, or “affinities,” may be computed by the online system 120 over time to approximate a user's interest in an object or in another user in the online system 120 based on the actions performed by the user. A user's affinity may be computed by the online system 120 over time to approximate the user's interest in an object, in a topic, or in another user in the online system 120 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 220, in one embodiment. Alternatively, each interaction between a user and a specific object is stored as a separate edge. In some embodiments, connections between users may be stored in the user profile store 200, or the user profile store 200 may access the edge store 220 to determine connections between users.

In one embodiment, the online system 120 identifies stories likely to be of interest to a user through a “newsfeed” presented to the user. A story presented to a user describes an action taken by an additional user connected to the user and identifies the additional user. In some embodiments, a story describing an action performed by a user may be accessible to users not connected to the user that performed the action. The newsfeed manager 235 may generate stories for presentation to a user based on information in the action log 215 and in the edge store 220 or may select candidate stories included in the content store 205. One or more of the candidate stories are selected and presented to a user by the newsfeed manager 235.

For example, the newsfeed manager 235 receives a request to present one or more stories to an online system user. The newsfeed manager 235 accesses one or more of the user profile store 200, the content store 205, the action log 215, and the edge store 220 to retrieve information about the identified user. For example, stories or other data associated with users connected to the identified user are retrieved. The retrieved stories or other data are analyzed by the newsfeed manager 235 to identify candidate content items, which include content having at least a threshold likelihood of being relevant to the user. For example, stories associated with users not connected to the identified user or stories associated with users for which the identified user has less than a threshold affinity are discarded as candidate stories. Based on various criteria, the newsfeed manager 235 selects one or more of the candidate stories for presentation to the identified user.

In various embodiments, the newsfeed manager 235 presents stories to a user through a newsfeed including a plurality of stories selected for presentation to the user. The newsfeed may include a limited number of stories or may include a complete set of candidate stories. The number of stories included in a newsfeed may be determined in part by a user preference included in user profile store 200. The newsfeed manager 235 may also determine the order in which selected stories are presented via the newsfeed. For example, the newsfeed manager 235 determines that a user has a highest affinity for a specific user and increases the number of stories in the newsfeed associated with the specific user or modifies the positions in the newsfeed where stories associated with the specific user are presented.

The newsfeed manager 235 may also account for actions by a user indicating a preference for types of stories and selects stories having the same, or similar, types for inclusion in the newsfeed. Additionally, the newsfeed manager 235 may analyze stories received by the online system 120 from various users to obtain information about user preferences or actions from the analyzed stories. This information may be used to refine subsequent selection of stories for newsfeeds presented to various users.

The web server 240 links the online system 120 via the network 115 to the one or more client devices 110, as well as to the one or more third party systems 130. The web server 240 serves web pages, as well as other content, such as JAVA®, FLASH®, XML and so forth. The web server 240 may receive and route messages between the online system 120 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 205. Additionally, the web server 240 may provide application programming interface (API) functionality to send data directly to native client device operating systems, such as IOS®, ANDROID™, or BlackberryOS.

### Identifying and Adjusting for Systemic Biases in Quality Component Scores

When a user of an online system 120 accesses a page, the online system 120 identifies content items for presentation to the user through a selection process. Content items that compete for presentation may be items in a newsfeed, items in a content discovery UI, search results in response to a query, sponsored content, or any other UI. The online system 120 ranks content items for users using a score associated with each content item and presents content items based on the ranking. For example, the online system 120 selects content items based on achieving a threshold content score. In another example, the online system 120 selects content items based on achieving a threshold position in the ranking.

The content item score used in the selection process ranking represents a probability that the viewing user will interact with the content item upon being presented with the content item (e.g., ‘liking’ the item, commenting on the item, clicking on an external link associated with the item). The content item score may additionally be influenced by scores that are not associated with user action on the content item, such as professional raters' score predictions and bakeoff score predictions. The score includes a quality component that describes the quality of the content item. Other components may exist, such as monetary compensation to the online system 120 for sponsored content items.

The online system 120 uses a machine learning model to predict the quality component of the content item score. The model uses various factors associated with both the content item and the user for whom the selection process is being conducted to determine a quality score. For example, the online system 120 can consider features about the content item itself, features about historical interactions by other users with the content item, features about the user to whom the content is being presented, features about the user's previous interactions with other content, and others. The online system 120 may further consider the connection between a viewing user and a posting user, the interests of the viewing user, the timestamp associated with the content item, the targeted user demographic of the content item, the quality of associated external pages of the content item, and others. The machine learning model is trained using historical data about previously presented content items and whether users of the online system interacted with the content items. In one embodiment, the machine learning model additionally is trained using professional rating services. A professional rating service, which may be a third party service, determines a quality score for content items and may be considered to represent a ground truth quality score. Using the historical data and professional quality ratings, the machine learning model generates a baseline quality score associated with the content items competing for presentation in a selection process for a given user. The computed quality score is particular to both the content item and to the viewing user for whom the online system 120 is generating content items. The quality score is then used as a component in the content item score for the ranking process.

The online system 120 may categorize content items based on a number of factors. For example, a content item type may categorize content items based on media form (e.g., video, photos, posted text, check-ins at locations, newsfeed stories about user actions, or sponsored items). In another example, a content item type may categorize content items based on the goal of the content item. The goal of the content item is determined based on an external link associated with the content (e.g., an external link to install a mobile app, an external link to watch a movie trailer, or an external link to a shopping website).

Systemic biases may occur in how the machine learning model scores certain types of content items. A bias occurs when the machine learning model predicts too high or too low of a quality score systematically for a certain type of content as compared with what the actual quality score should be. Because the same model is used for all content items, biases in the model result in skewed predictions for quality scores and impact the performance of types of content items during the selection process. Professional rating services are used to determine a ground truth quality score for content items. Accordingly, a bias occurs when the predicted quality score deviates by more than a threshold amount from the ground truth quality score determined by the professional rating service.

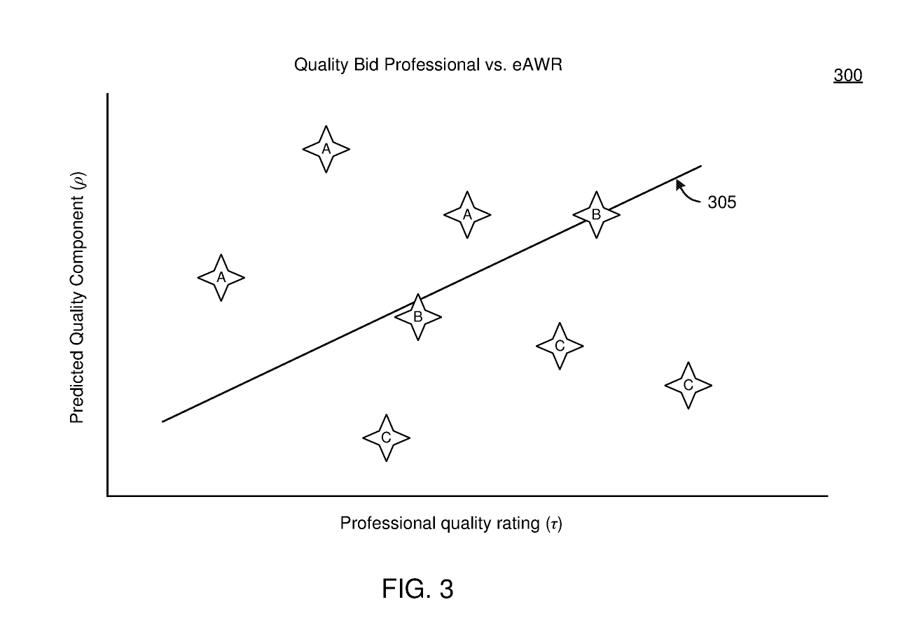

To determine if systemic biases occur, the system 120 obtains a professional rating on content items and determines a predicted quality score based on the machine learning model. The professional quality score and the predicted quality score are then compared using a curve fit to determine if the predicted quality score deviates from the professional quality score by more than a threshold amount. If a similar deviation occurs for multiple content items of the same type, a systemic bias occurs with the content item of the given type, as described in FIG. 3.

FIG. 3 is an example illustrating calculations for identifying systemic biases in the model's predicted quality component for different types of content, in accordance with an embodiment. The system uses a plurality of content items to determine whether systemic biases occur in the machine learning model for predicting quality scores. Each of the plurality of content items is associated with a predicted quality score from the machine learning model, as well as a quality rating determined by a professional rating service to be used as the ground truth rating. To determine from the professional quality rating and the model predicted quality score whether systemic biases exist in the model, the system determines a relationship between the professional quality ratings and the model predicted quality scores of the content items.

As shown in FIG. 3, the predicted quality components of the plurality of content items are plotted against the professional quality ratings for those content items. These points are then fitted with a linear regression 305.

τ=kρ+c (Equation 1)

The linear regression 305 describes the relationship between the professional quality rating τ and the predicted quality metric ρ by relating them with constants k and c. The system determines the constants k and c based on the plurality of posts using, e.g., a linear regression.

The plurality of posts are then segmented into categories (e.g., by goal). The segmented posts are compared by category to the linear regression. Categories of posts above the linear regression 305 by a threshold amount are identified as experiencing consistent and unfair subsidies, while categories of posts below the linear regression 305 by a threshold amount are identified as experiencing consistent and unfair penalties. For example, FIG. 3 shows that posts categorized as “A” statistically exceed the linear regression for the content items as a whole, thus identifying an unfair positive bias for content items of type “A” in the model for predicting quality. In comparison, posts categorized as “B” follow the linear regression and do not receive an unfair statistically systematic bias, and posts categorized as “C” generally fall below the linear regression and thus receive an unfair negative bias from the model.

In some cases, some amount of offset from the linear regression may occur even in content item types that are not biased. Accordingly, the system identifies biases based on content item types experiencing statistically significant deviations from the linear regression. In one embodiment, as shown in FIG. 3, a statistically significant deviation is determined based on the error of each content item of a given type. The error is represented as the height offset of the content item from the linear regression. The errors are aggregated across a content item type. For example, the system may calculate the average height offset, the root mean squares, the least squares error, or perform another statistical analysis on the error of the content item type. In another embodiment, the system determines a curve fit for the content item type (e.g., a linear regression performed only on type “A” content items) and compares the content item type curve fit to the curve fit based on all of the content items. If the k and c terms are off by more than a threshold amount, the system identifies the content item type as experiencing a bias. In other embodiments, the system may apply other forms of statistical analysis to the content items to determine if they deviate from the linear regression.

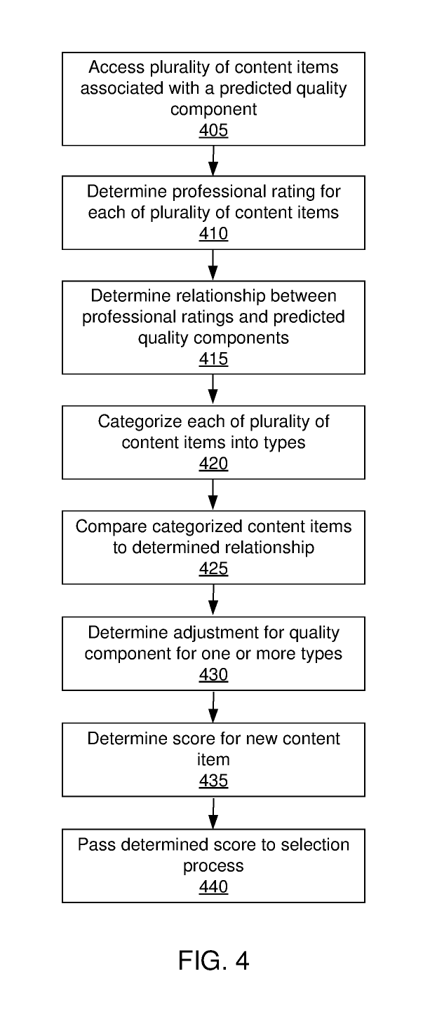

FIG. 4 is a flow diagram of a method for identifying and adjusting for systemic biases in quality metrics of content, in accordance with an embodiment. In various embodiments, the method may include different and/or additional steps and the steps may be performed in different orders than those described in conjunction with FIG. 4.

The system accesses a plurality of content items 405 from the content store 205. Each content item of the plurality of content items has been previously delivered by the online system 120 to users of the online system via a selection process based on a score for the content item that includes a predicted quality component. The predicted quality component is determined by the online system 120 using a machine learning model. The system determines a professional rating 410 for each of the plurality of content items. The professional rating is provided by a professional rater or professional rating service, which may be a third party service. The professional rating is used as the ground truth for the quality component of the content items.

The system determines a relationship 415 between the professional ratings and the predicted quality components for the content items. In one embodiment, as described in Equation 1, the relationship is defined as a linear regression. The plurality of content items are categorized into types 420 based on common characteristics (e.g., by goal, media type, or other characteristic). The categorized content items are compared to the determined relationship 425. In one embodiment, the comparison calculates the error associated with each content item of the content item type, represented as the offset of the content item from the determined relationship. The system aggregates the errors associated with the content items of a given type to produce a value that represents the deviation of the content item type from the determined relationship. The aggregated value may be determined as an average height offset, a root mean square, a least squares error, or another statistical analysis. For values that exceed a statistically significant threshold magnitude, the system identifies a bias for the content item type. In another embodiment, the comparison is performed by determining a relationship between the professional ratings and the predicted quality components of the content items of the given type. For example, the system determines a second linear regression to represent the content type. The system then compares the relationship of the content item type to the overall relationship. Content item types associated with a relationship that deviates more than a statistically significant threshold amount from the overall relationship are identified as experiencing a bias in the model.

Based on the results of comparing the categorized content items to the determined relationship, the system determines an adjustment for the quality component for the one or more types of content items. The determined adjustment is based on the differences between the content items and the determined relationship. For example, a content item type with an average height offset from the determined relationship of +5 is considered to be unfairly subsidized. Accordingly, the system adjusts the quality component of content items of that type downward by an equivalent −5. In another example, a content item type with an average height offset from the determined relationship of −3 is considered to be unfairly penalized. Accordingly, the system adjusts the quality component of content items of that type upward by an equivalent +3.

When an opportunity to present content to a user of the online system 120 occurs, the online system 120 performs a selection process to identify content items to present to the user. The system accesses a plurality of candidate content items. The candidate content items may be user posted content (e.g., text posts, videos, photos, etc.) or sponsored content (e.g., advertisements). Each candidate content item is associated with a score. For at least some of the candidate content items, the associated score includes a quality component computed by the machine learning model. The online system 120 identifies one or more ‘types’ associated with each content item. For content items with a ‘type’ identified as experiencing a bias from the machine learning model and having a quality component in the content item score, the system adjusts the quality component of the content item to compensate for the bias. Based on the adjusted quality component, the system determines an adjusted content item score. The plurality of content items is then passed to a selection process for the opportunity. The selection process identifies one or more content items for presentation to the viewing user, based at least in part on the content item score associated with the content items. In one embodiment, the selection process identifies content items for presentation based on the content items having at least a threshold content item score. In another embodiment, the selection process identifies content items for presentation based on the content items having at least a threshold position in a list of content items ranked based on the content item score. The online system 120 delivers the identified content items to the viewing user for presentation.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
accessing a plurality of content items previously delivered by an online system to users of the online system, where each content item was selected for the users based on a score for the content item that included a predicted quality component determined by the online system using a machine learning model;
determining a professional rating for each of the plurality of content items, the professional rating provided by a professional rater;
determining a relationship between the professional ratings and the predicted quality components for the content items;
categorizing each of the plurality of items into one of a plurality of different types;
for one or more of the plurality of types, comparing the content items categorized into the type to the determined relationship to identify a statistically significant difference between the compared content items of the type and the determined relationship for all the content items;
determining an adjustment for the quality component for one or more of the types of content items based on the differences between the content items and the determined relationship;
for ranking a new content item for presentation to one or more of the users of the online system, determining a score for the new content item by using the machine learning model to predict the quality component of the score and adjusting the quality component by the determined adjustment for the type of the new content item; and
passing the determined score for the content item to a selection process that selects content to present to the users of the online system.

2. The method of claim 1, wherein determining a relationship between the professional ratings and the predicted quality components for the content items having that type comprises fitting a linear model to the professional ratings and the predicted quality components for the content items having that type.

3. The method of claim 1, wherein the machine learning model is trained to predict a quality component score by a professional rating service based on a training set of data that includes quality ratings from the professional rating services and contextual data about historical content item delivery to users of the online system.

4. The method of claim 1, wherein the content items comprise user posts to the online system for sharing with other users of the online system.

5. The method of claim 1, wherein the content items comprise sponsored content provided by the online system in exchange for compensation provided to the online system.

6. The method of claim 1, wherein the content items comprise newsfeed items generated by the online system about actions taken by users of the online system and for sharing with other users of the online system.

7. The method of claim 1, wherein the content item type is determined based on one or more of: whether the content item includes an image, whether the content image includes a video, and whether the content item includes a newsfeed story.

8. The method of claim 1, wherein the content item type is determined based on a type of action specified by a link contained within the content item.

9. The method of claim 8, wherein the types of actions used to determine the content item type comprises one or more of: purchasing a product, interacting with content on the online system, watching a video, and installing a mobile application.

10. The method of claim 1, wherein the determined adjustments offset at least in part the identified difference between the determined relationship and the different types of content items.

11. A non-transitory computer-readable storage medium storing computer program instructions executable by a processor to perform operations comprising:
accessing a plurality of content items previously delivered by an online system to users of the online system, where each content item was selected for the users based on a score for the content item that included a predicted quality component determined by the online system using a machine learning model;
determining a professional rating for each of the plurality of content items, the professional rating provided by a professional rater;
determining a relationship between the professional ratings and the predicted quality components for the content items;
categorizing each of the plurality of items into one of a plurality of different types;
for one or more of the plurality of types, comparing the content items categorized into the type to the determined relationship to identify a statistically significant difference between the compared content items of the type and the determined relationship for all the content items;
determining an adjustment for the quality component for one or more of the types of content items based on the differences between the content items and the determined relationship;
for ranking a new content item for presentation to one or more of the users of the online system, determining a score for the new content item by using the machine learning model to predict the quality component of the score and adjusting the quality component by the determined adjustment for the type of the new content item; and
passing the determined score for the content item to a selection process that selects content to present to the users of the online system.

12. The computer-readable storage medium of claim 10, wherein determining a relationship between the professional ratings and the predicted quality components for the content items having that type comprises fitting a linear model to the professional ratings and the predicted quality components for the content items having that type.

13. The computer-readable storage medium of claim 10, wherein the machine learning model is trained to predict a quality component score by a professional rating service based on a training set of data that includes quality ratings from the professional rating services and contextual data about historical content item delivery to users of the online system.

14. The computer-readable storage medium of claim 10, wherein the content items comprise user posts to the online system for sharing with other users of the online system.

15. The computer-readable storage medium of claim 10, wherein the content items comprise sponsored content provided by the online system in exchange for compensation provided to the online system.

16. The computer-readable storage medium of claim 10, wherein the content items comprise newsfeed items generated by the online system about actions taken by users of the online system and for sharing with other users of the online system.

17. The computer-readable storage medium of claim 10, wherein the content item type is determined based on one or more of: whether the content item includes an image, whether the content image includes a video, and whether the content item includes a newsfeed story.

18. The computer-readable storage medium of claim 10, wherein the content item type is determined based on a type of action specified by a link contained within the content item.

19. The computer-readable storage medium of claim 18, wherein the types of actions used to determine the content item type comprises one or more of: purchasing a product, interacting with content on the online system, watching a video, and installing a mobile application.

20. The computer-readable storage medium of claim 10, wherein the determined adjustments offset at least in part the identified difference between the determined relationship and the different types of content items.
